(19) United States
(12) Patent Application Publication
(10) Pub. No.: US 2008/0216010 A1
(43) Pub. Date: Sep. 4, 2008

(54) METHOD AND SYSTEM FOR DISPLAYING HIERARCHICAL INFORMATION

(75) Inventor: David Lareau, Oakton, VA (US)

Correspondence Address: BUCHANAN, INGERSOLL & ROONEY PC, POST OFFICE BOX 1404, ALEXANDRIA, VA, 22313-1404, US

(73) Assignee: MEDICOMP SYSTEMS, INC., Chantilly, VA (US)

(21) Appl. No.: 12/021,995

(22) Filed: Jan. 29, 2008

Related U.S. Application Data
(60) Provisional application No. 60/897,821, filed on Jan. 29, 2007.

(51) Int. Cl. G06F 3/048

(52) U.S. Cl. 715/783

(57) ABSTRACT

Disclosed are methods and systems for displaying data elements in hierarchical databases in multiple frames. The method includes assigning attributes to data elements and sub-data elements in a hierarchical database. The data elements and sub-elements are in a parent-child relationship. The method further includes distributing a portion of the data elements in the database for display based on the attribute assigned to the distributed data elements and sub-data elements and displaying the distributed data elements and sub-data elements to a user by configuring a display in a plurality of individual frames. Individual frames of the plurality of frames are configured to display both distributed data elements and sub-data elements having related attributes simultaneously. The system includes hardware and software to carry out the method.

### CROSS-REFERENCE TO RELATED APPLICATIONS

This application claims priority from U.S. Provisional Patent Application Ser. No. 60/897,821, filed Jan. 29, 2007, the disclosure of which is hereby incorporated by reference in its entirety.

### BACKGROUND

1. Field

The subject matter presented herein relates generally to methods and systems for displaying data of a hierarchical information database, and more particularly, to displaying data used for assessing and evaluating the condition of a patient and for creating a record of the encounter with the patient.

2. Description of Related Art

Information in a hierarchy is, by definition, in layers. Thus, you cannot see the information at a lower layer without selectively displaying it. In current computer files, this requires clicking down to the lower layer whereupon all information at that level is displayed in a vertical column. If there are many pieces of information at that level, it may scroll off the bottom, resulting in the user having to scroll down, or, worse, being unaware that it is there. The desired information may reside at a second or third level down, requiring the user to click down, repetitively, until it is found.

### SUMMARY

Disclosed are methods and systems for displaying data elements in hierarchical databases in multiple frames. The method includes assigning attributes to data elements and sub-data elements in a hierarchical database, wherein the data elements and sub-elements are in a parent-child relationship, distributing a portion of the data elements in the database for display based on the attribute assigned to the distributed data elements and sub-data elements and displaying the distributed data elements and sub-data elements to a user by configuring a display in a plurality of individual frames, wherein individual frames of the plurality of frames are configured to display both distributed data elements and sub-data elements having related attributes simultaneously. The system includes a means for assigning attributes to data elements and sub-data elements in a hierarchical database, wherein the data elements and sub-elements are in a parent-child relationship, a means for distributing a portion of the data elements in the database for display based on the attribute assigned to the distributed data elements and sub-data elements, and a means for displaying the distributed data elements and sub-data elements to a user by configuring a display in a plurality of individual frames, wherein individual frames of the plurality of frames are configured to display both distributed data elements and sub-data elements having related attributes simultaneously.

As will be realized, different embodiments are possible, and the details herein are capable of modification in various respects, all without departing from the scope of the claims. Accordingly, the drawings and descriptions are to be regarded as illustrative in nature and not as restrictive.

### BRIEF DESCRIPTION OF THE DRAWINGS

FIG. 1 illustrates an expanded display of data elements according to an exemplary embodiment.

FIG. 2 illustrates an exemplary view of a data element expanded within a frame.

FIG. 3 illustrates an exemplary expanded view of parent and child data elements using an attribute method in an expanded frame view.

FIG. 4 illustrates another exemplary view of a data element expanded within a frame.

FIG. 5 illustrates another exemplary expanded view of parent and child data elements in an expanded frame view.

FIG. 6 illustrates a further expansion of the expanded frame view using a division method to the bottom level of the hierarchical database.

FIG. 7 illustrates an exemplary system for implementing an embodiment of the above described method.

### DETAILED DESCRIPTION

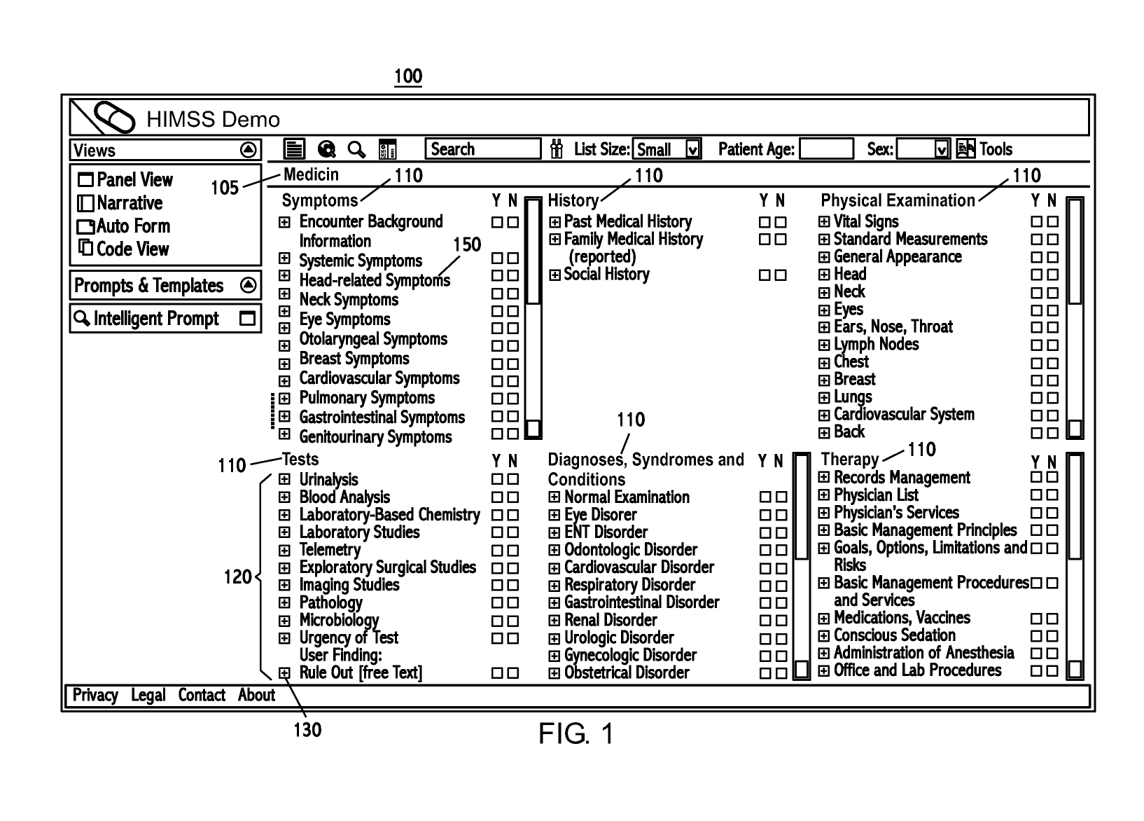

In one embodiment of a method for displaying data elements in a hierarchical database in a plurality of frames, FIG. 1 illustrates an expanded display 100 of the data elements 110 under the main data element 105. Main data element 105 can be any data element that has parent data elements 110 beneath it in the hierarchical data structure or database. Attributes can be assigned to data elements 110 and sub-data elements in a hierarchical database, wherein the data elements and sub-elements are in a parent-child relationship.

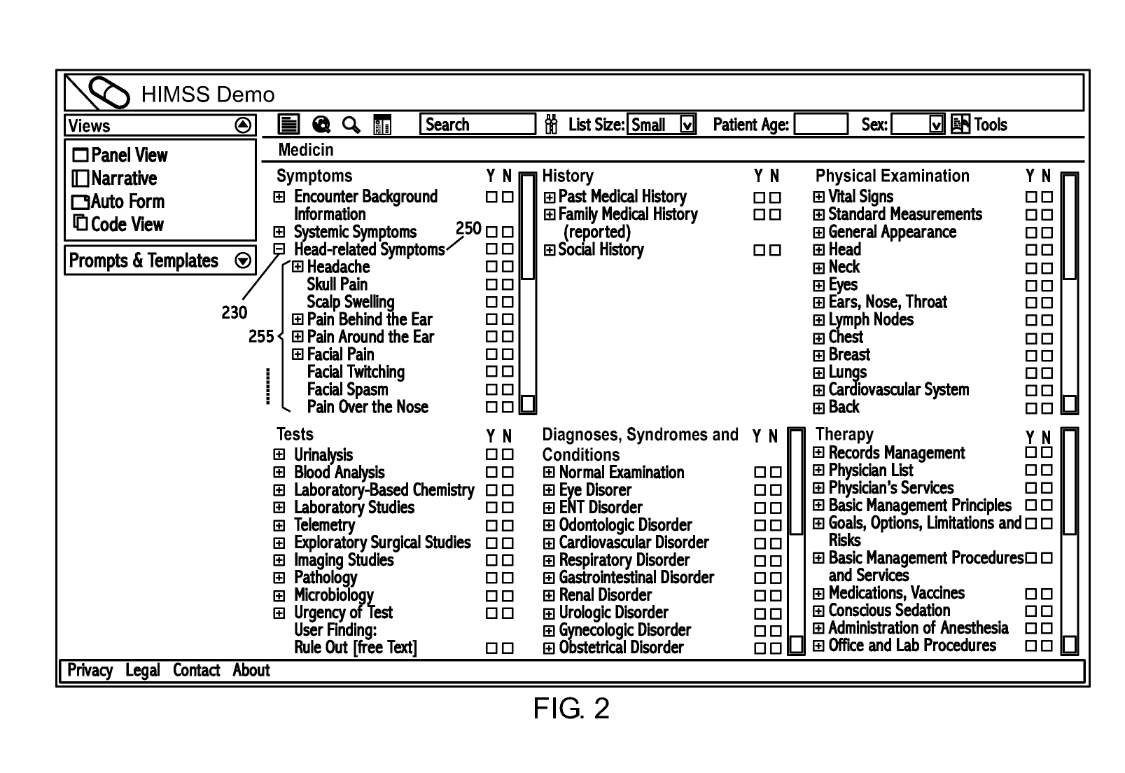

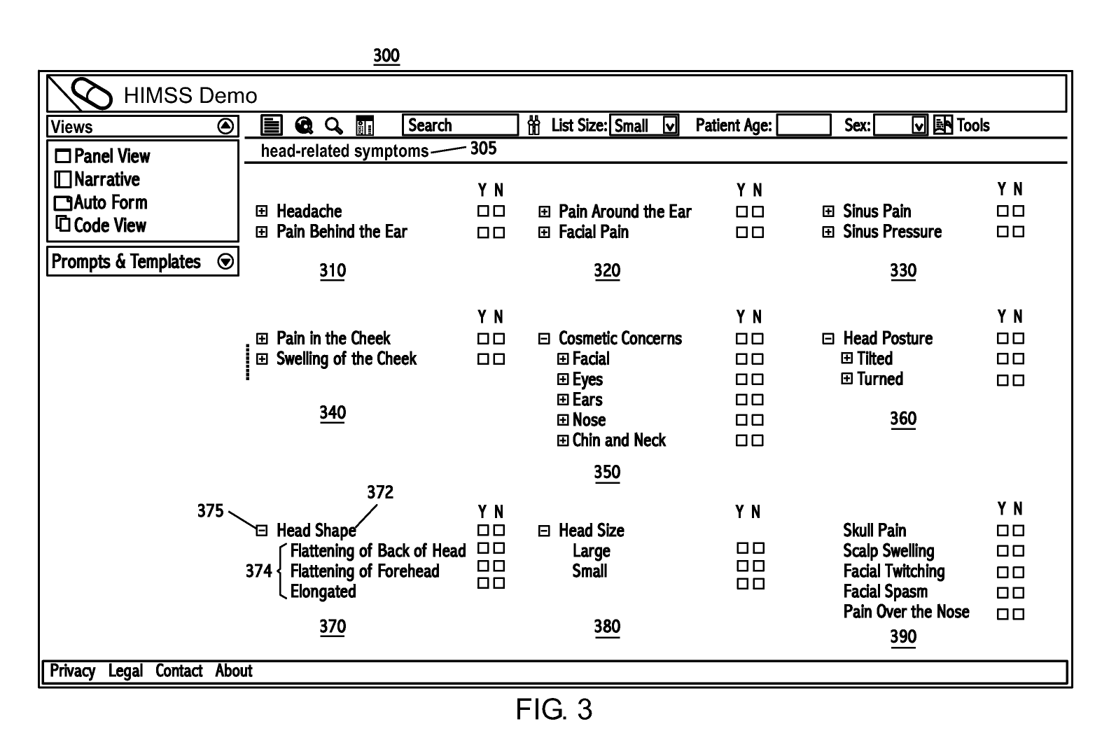

Further down in the hierarchical database are child data elements 120. Note that each child data element 120 has plus block 130 beside it. Each of the plus blocks 130 indicates that there are additional data elements, i.e., grand-child, below each of the child data elements 120 having an associated plus block 130. Since this is a view of the very high levels of the data in the hierarchical database, most of the child data elements 120 will have the plus block 130. Of course, the opposite of a plus block will be a minus block or no block, both of which will be discussed later with reference to FIGS. 2 and 3, respectively.

In the presently described display method as in FIG. 1, the data element or information may be displayed in multiple frames or boxes, indicated by data elements 110 on the screen by one of the following two exemplary methods: an attribute method and a division method.

In one embodiment, in the attribute method, each data element 110 and child data element 120 can be assigned one of several attribute codes when the database is created appropriate to the kind of information represented by the particular data element 110 or child data element 120. Then, when it is desired to display the information, all the data elements 110, child data elements 120 and so on in the hierarchy may be distributed to the frames using the attribute codes, i.e., the method includes distributing a portion of the data elements in the database for display based on the attribute assigned to the distributed data elements and sub-data elements. Each data element is thus displayed in a frame containing similar kinds of information. Thus, the method includes displaying the distributed data elements and sub-data elements to a user by configuring a display in a plurality of individual frames, wherein individual frames of the plurality of frames are configured to display both distributed data elements and sub-data elements having related attributes simultaneously. Since the information can be of a similar kind, the next level down may also be displayed, appropriately indented. This means that in addition to being categorized, two levels of each kind of information can be displayed at once, thus greatly reducing the number of clicks for the viewer to find the desired information.

In one embodiment, in the division method, the information can be distributed equally by simple division to the desired number of frames. A third second level may be displayed (FIG. 3), appropriately indented, depending on the size of the hierarchy. This second method would be appropriate where the kinds of information vary too widely for categorization to be useful or where the information is all of one type.

In the FIG. 1 example, there are six boxes or frames, each with data elements 110 according to an attribute of finding type: Symptoms, History, Physical findings, Tests, Diagnoses and Therapy. The attribute, for example, can be a letter, such as S, H, P, T, D and Rx, a number, symbol or any combination thereof.

Still referring to FIG. 1, if a user were to select the plus block 130 beside data element 150 “Head-related Symptoms”, it would expand to expose grand-child data elements as shown in FIG. 2.

FIG. 2 illustrates an example of an expanded view of a child data element 250. By the user selecting the plus block 130, it changes to a minus block 230, exposing grand-child data elements 255.

However, returning to the FIG. 1 example, if a user were to double-click on the text of the child data element 150 “Head-related Symptoms”, the next level of data elements (grand-child data elements) is displayed in nine frames, in this case, distributed by simple division. This is an example of the Division method of expanding the data and is illustrated in FIG. 3. FIG. 3 illustrates a data view 300 comprising main data element 305 “head-related symptoms,” and nine frames 310-390.

In one embodiment, Frame 370 provides an example of a minus block 375. In this frame view, not only can the grand-child data element 372 “Head Shape” be shown to the user, but also great-grand-child data elements 374. Frame 360 provides a similar view. Frame 390 illustrates an example of no plus or minus blocks. The data elements in the lower right frames in this embodiment can be allocated the lowest level data in the hierarchical database for the selected child data element, which was element 250 of FIG. 2.

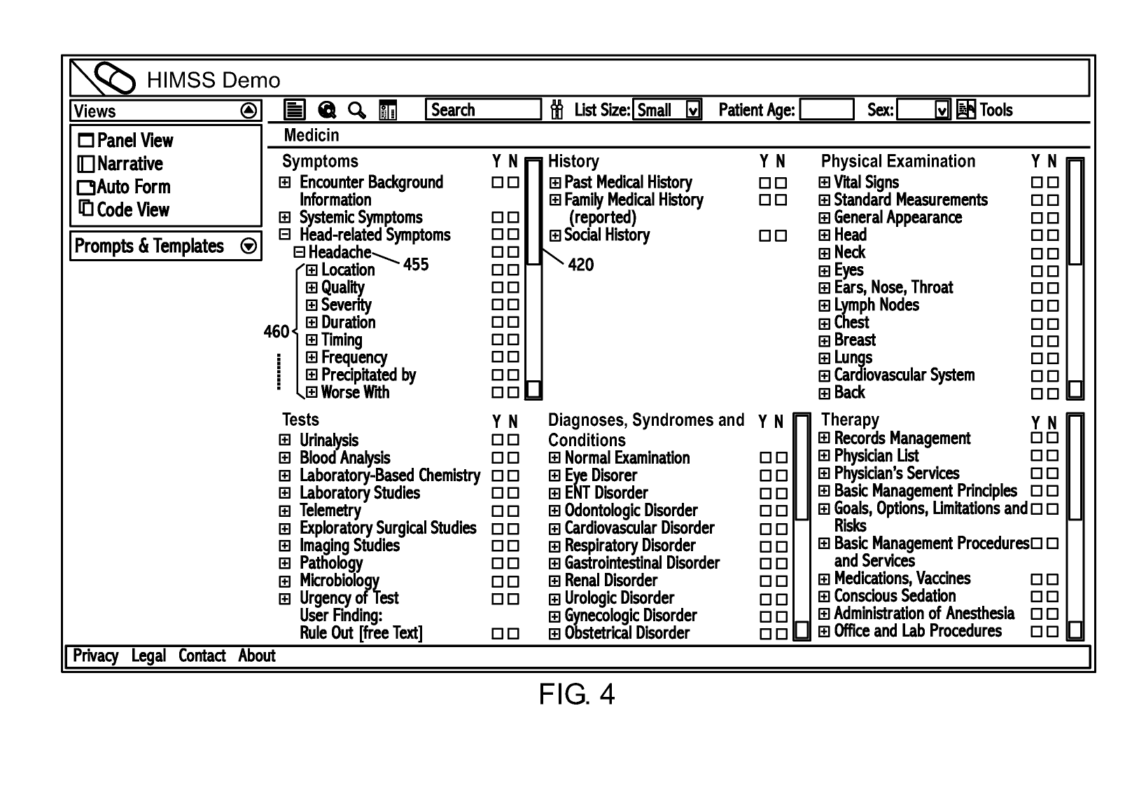

In one embodiment, FIG. 4 illustrates the expansion of child data element 150 to reveal grand-child data element 455 “Headache,” which has great-grand-children data elements 460, e.g., location, quality, severity, duration and so on. In fact, other great-grand-children data elements 460 would be viewable by pulling down slide bar 420. The slide bar 420 can be displayed when the number of data elements to be displayed is greater than the size of the frame. The number of data elements can be determined by the attributes assigned to each data element.

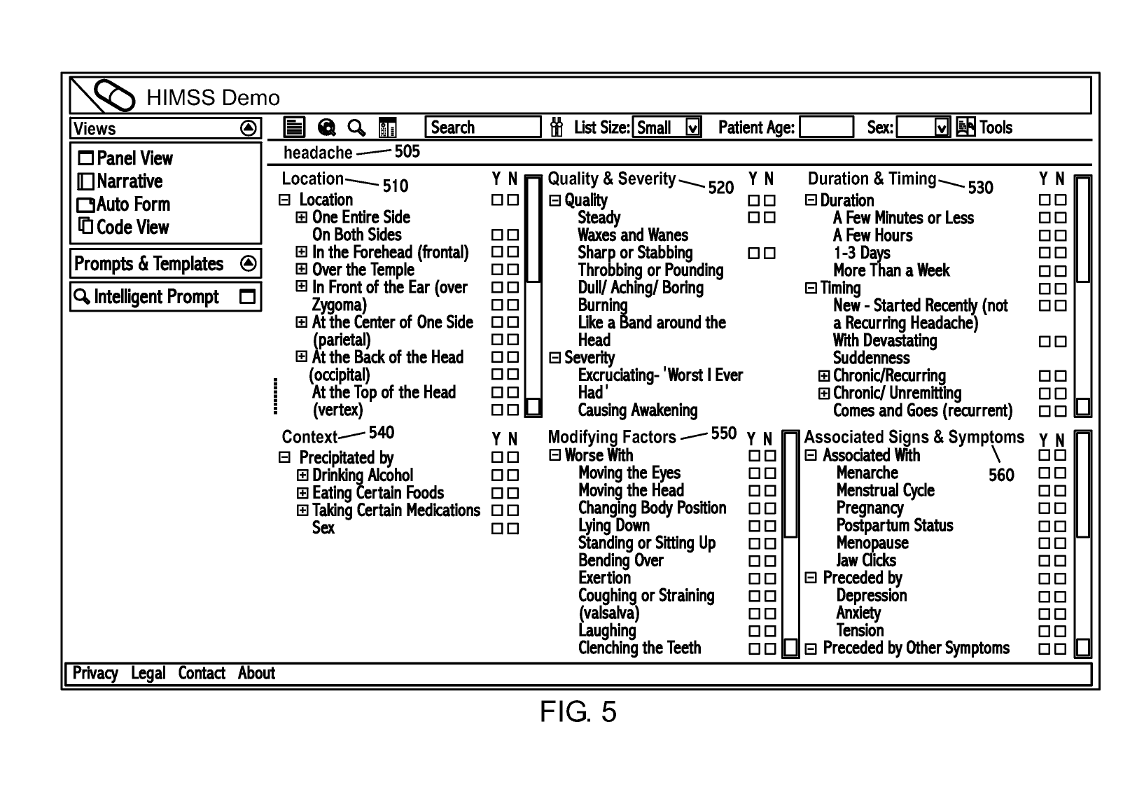

However, if a user were to double-click on data element 455 “Headache,” in one embodiment, the resulting display would look like FIG. 5. In FIG. 5, the main data element is 505 “headache,” and the next level of data elements, “location” 510, “quality & severity” 520, “duration & timing” 530, “context” 540, “modifying factors” 550 and a catch-all “associated signs & symptoms” 560, are distributed into six frames based on attributes assigned to each of the data elements. The names corresponding to each of the attributes are at the top of each frame in this embodiment. Note that in some cases, two attributes are shown in a single frame, such as Quality and Severity, or Duration and Timing.

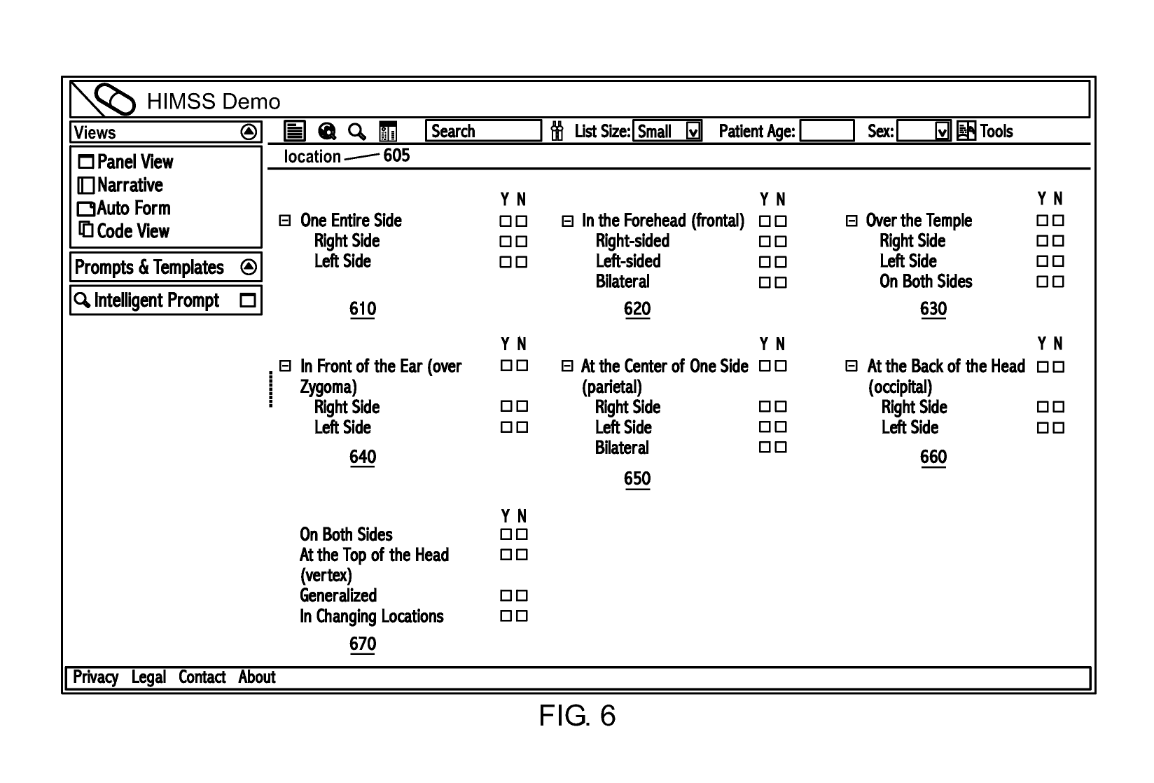

Referring to FIG. 6, in one embodiment, to view even lower levels of the hierarchy, if the user were to double-click the data element “location” 510 in FIG. 5, a new widow would appear with the main data element 605 being entitled “location,” and each frame 610-670 would list information represented by data elements beneath headache location in the hierarchical database.

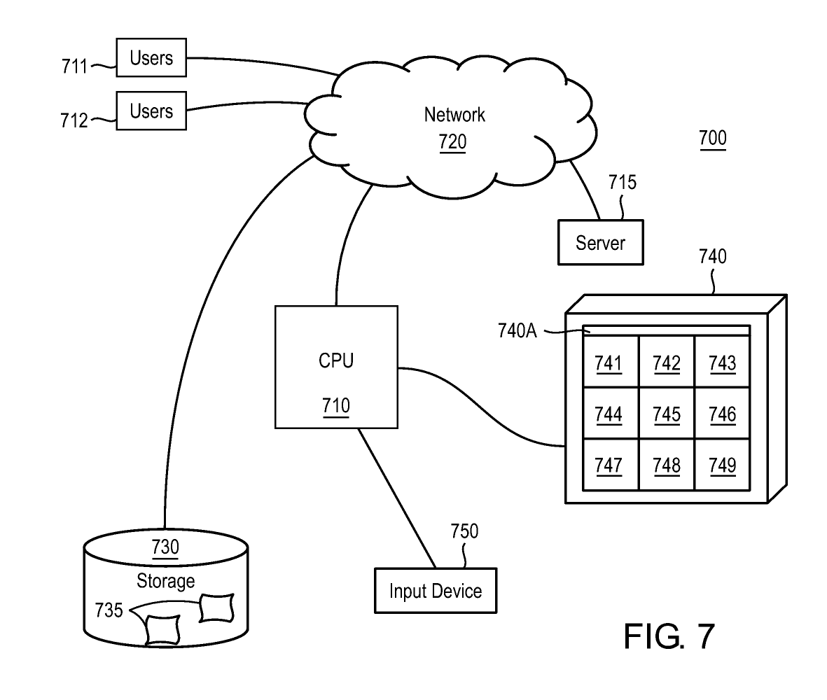

FIG. 7 illustrates an exemplary system for displaying data elements in hierarchical databases in multiple frames implementing an embodiment of the above described method. The system 700 includes a central processing unit (CPU) 710, a network 720, a storage device 730 for storing a database 735 with data arranged in a hierarchy, a display device 740 and an input device 750. The central processing unit 710 can be, for example, one of many personal computers, which can be connected to a network 720. As noted above, the data elements and sub-elements can be in a parent-child relationship and each data element and child data element can be assigned one of several attribute codes when the database is created appropriate to the kind of information represented by the particular data element or child data element. Then, when it is desired to display the information, the data elements, child data elements and so on in the hierarchy may be distributed to the frames using the attribute codes. Each data element is thus displayed in a frame containing similar kinds of information. The network 720 can be an intranet or the Internet, and may be connected to server 715. The display device 740 can be a computer monitor having a display 740A. A web browser may be used in conjunction with the display 740A to present the data.

The display 740A can present data in one of a plurality of frames 741-749 by using an exemplary embodiment of the disclosed method.

In one embodiment, the mapping of the frames and the related data in the web browser can be accomplished using a variety of languages, such as the mark-up language XML, AJAX, Java, JavaScript or a combination thereof. The size of the frames within the browser window as shown in FIG. 1, for example, can be of any size or number as determined by the designer. XML commands for mapping the data elements to a particular frame or other part of the display can be embedded with the data information being retrieved from the server by the user's web browser. A suitable web browser is, for example, Microsoft Internet Explorer 7.0 or other web browser having similar functionality and capabilities as Microsoft Internet Explorer 7.0. In addition, exemplary embodiments can take advantage of Web 2.0 concepts.

In one embodiment, the server 715 contains software that that is downloadable to the CPU 710. The connection between CPU 710 and server 715 may last only as long as it takes to download instructions for executing an exemplary embodiment of the disclosed method. The downloaded instructions may be executed by the CPU 710. This frees the server to connect with other users such as 711 and 712. The server 715 may store the instructions executed by the CPU 710 on computer readable storage devices. Examples of computer readable storage devices include RAID arrays, compact discs, hard drives, flash memory, digital versatile discs, random access memory and the like.

The above description is presented to enable a person skilled in the art to make and use the methods and systems described herein, and is provided in the context of a particular application and its requirements. Various modifications to the embodiments will be readily apparent to those skilled in the art, and the generic principles defined herein may be applied to other embodiments and applications without departing from the spirit and scope of the claims. Thus, there is no intention to be limited to the embodiments shown, but rather to be accorded the widest scope consistent with the principles and features disclosed herein.

What is claimed is:

1. A method for displaying data elements in a hierarchical database in a plurality of frames, comprising:
assigning attributes to data elements and sub-data elements in a hierarchical database, wherein the data elements and sub-elements are in a parent-child relationship;
distributing a portion of the data elements in the database for display based on the attribute assigned to the distributed data elements and sub-data elements; and
displaying the distributed data elements and sub-data elements to a user by configuring a display in a plurality of individual frames, wherein individual frames of the plurality of frames are configured to display both distributed data elements and sub-data elements having related attributes simultaneously.

2. The method of claim 1, wherein displaying the distributed data elements comprises configuring data elements across frames according to assigned attributes of the information.

3. The method of claim 1, wherein distributing a portion of data elements comprises distributing the data elements across frames in the absence of assigned attributes.

4. A system for displaying data elements in hierarchical databases in multiple frames, comprising:
a means for assigning attributes to data elements and sub-data elements in a hierarchical database, wherein the data elements and sub-elements are in a parent-child relationship;
a means for distributing a portion of the data elements in the database for display based on the attribute assigned to the distributed data elements and sub-data elements; and
a means for displaying the distributed data elements and sub-data elements to a user by configuring a display in a plurality of individual frames, wherein individual frames of the plurality of frames are configured to display both distributed data elements and sub-data elements having related attributes simultaneously.

5. A computer-readable medium containing instructions for causing a computer to execute a method for displaying data elements in a hierarchical database in a plurality of frames by a method comprising:
assigning attributes to data elements and sub-data elements in a hierarchical database, wherein the data elements and sub-elements are in a parent-child relationship;
distributing a portion of the data elements in the database for display based on the attribute assigned to the distributed data elements and sub-data elements; and
displaying the distributed data elements and sub-data elements to a user by configuring a display in a plurality of individual frames, wherein individual frames of the plurality of frames are configured to display both distributed data elements and sub-data elements having related attributes simultaneously.
